(19) United States
(12) Patent Application Publication
(10) Pub. No.: US 2026/0229201 A1
(43) Pub. Date: Aug. 6, 2026

(54) RAIL COMPONENT OF KEYBOARD INSTRUMENT AND CAP MEMBER FOR THE RAIL COMPONENT

(71) Applicant: KAWAI MUSICAL INSTRUMENTS MANUFACTURING CO., LTD., Hamamatsu-shi (JP)

(72) Inventor: Satoko YAMANE, Hamamatsu-shi (JP)

(21) Appl. No.: 19/451,164

(22) Filed: Jan. 16, 2026

(30) Foreign Application Priority Data
Jan. 20, 2025 (JP) 2025-007832

(51) Int. Cl. G10C 1/02; G10C 3/02; G10C 3/161; G10C 3/166

(52) U.S. Cl. CPC G10C 1/02; G10C 3/02; G10C 3/161; G10C 3/166

(57) ABSTRACT

A rail component for use in a keyboard instrument is provided. The rail component includes an elongated and hollow structure and at least one cap member covering at least one of two longitudinal ends of the rail component.

### CROSS-REFERENCE TO RELATED APPLICATIONS

The present application claims priority of Japanese Patent Application No. 2025-007832 filed on Jan. 20, 2025 with the Japan Patent Office, entire disclose of which is incorporated herein by reference.

### BACKGROUND

The present disclosure relates to a rail component for use in a keyboard instrument, such as a piano. The present disclosure also relates to a cap member for the rail component.

Known keyboard instruments such as pianos include, for example, the upright keyboard instrument disclosed in Japanese Unexamined Patent Application Publication No. 2005-283955 (Patent Document 1).

In the upright keyboard instrument, various mechanisms are provided for producing piano sounds. Such mechanisms include an action mechanism for producing sounds by striking of strings with hammers in response to depression of keys.

Components constituting some of such various mechanisms include rail components having elongated and hollow shapes. In general, the rail components include the following rail components.

### Muffler Rail

A muffler rail is linked to operation (movement) of a muffler lever (or muffler pedal) for muffling or reducing sounds of the keyboard instrument, and configured to transmit the operation force.

### Hammer Rail

A hammer rail is attached to a hammer assembly and supports hammers.

### Balance Lever Rail

A balance lever rail is coupled to a foot pedal and linked to operation (movement) of the pedal and configured to transmit the operation force.

In manufacturing, these rail components are each fabricated to a required length by cutting a base material that forms the rail component to a desired length. Due to the convenience of such a manufacturing process, in general a cut surface is formed at both ends of the rail components.

There is concern that both ends (cut surfaces) of the rail components may have burrs or other sharp projections not only in their as-cut state, but also in their finished state if any finishing work is performed thereon. The cut surfaces may be visible when a predetermined part(s) of the piano (top and/or side boards) is/are open, in addition to during assembly.

If burrs or other sharp projections remain, the burrs or other sharp projections may cause injury or other inconveniences during the assembly of the piano. In addition, the cut surfaces may be visible, which may produce an aesthetically negative effect.

Japanese Examined Utility Model Application Publication No. S58-29503 (Patent Document 2) discloses a hammer rail for a piano, and discloses, in particular, an idea of closing both ends of the hammer rail with caps.

### SUMMARY

The idea of Patent Document 2 was made to inhibit or reduce resonance of the hammer rail to thereby effectively inhibit a resonance phenomenon in which unwanted resonance sound is generated from the hammer rail. The technical idea of Patent Document 2 does not give any consideration to the problems described above such as those that may be caused by burrs or other sharp projections and those from an aesthetic perspective.

Thus, the problems related to the safety concerns during assembly and the aesthetic concerns remain as separate problems, and there is no indication that these problems can be solved.

The present disclosure discloses an example of a rail component of a keyboard instrument, such as a piano, that improves safety during assembly and aesthetics. The present disclosure also discloses a cap member for the rail component.

One aspect of the present disclosure provides a rail component for use in a keyboard instrument. The rail component comprises an elongated and hollow structure and at least one cap member covering at least one of two longitudinal ends of the rail component.

The rail component configured as above comprises at least one cap member covering at least one of two longitudinal ends of the rail component. Thus, for the end(s) covered with the cap member, it is possible, with the cap member, to inhibit exposure of burrs or other sharp projections that may have been produced during machining (cutting) of the rail component. As a result, it is possible to eliminate or reduce risks of injury or other inconveniences being caused by burrs or other sharp projections.

Covering the machined surface (cut surface) of the rail component with cap member makes it possible to hide the machined surface (cut surface). In other words, it is possible to prevent the machined surface (cut surface) from being seen. A machined surface (cut surface) without a finishing work provides a rough appearance, which is aesthetically undesirable; however, the cap member can avoid such a concern. Furthermore, finishing the cap member into an aesthetically pleasing component makes it possible to easily achieve the effect of improving the aesthetics as well.

In the rail component of the present disclosure, the cap member may comprise a material consisting of acrylonitrile butadiene styrene (ABS) resin. ABS resin can be easily molded, which is advantageous in ease of manufacturing and cost.

In the rail component of the present disclosure, the cap member may comprise a plated surface. In this case, it is possible to further improve the aesthetics of the cap member. In particular, the cap member having a surface plated with a material that matches the properties of the material of the rail component provides a unified appearance with the rail component. This is more advantageous from an aesthetic perspective.

In the rail component of the present disclosure, the plated surface may be configured with a coating material comprising brass. In this case, it is possible, depending on the type of the rail component, to improve the unified appearance (aesthetics) with the rail component. For example, the effect is higher in the case where the rail component is a hammer rail.

In the rail component of the present disclosure, the cap member may comprise a polished surface. In this case, it is possible to improve the aesthetics of the cap member, and consequently, that of the rail component.

Another aspect of the present disclosure provides a cap member for a rail component. The rail component is configured for use in a keyboard instrument and comprises an elongated and hollow structure. The cap member is configured to cover at least one of two longitudinal ends of the rail component. Such a cap member can similarly achieve the above-described effects.

### BRIEF DESCRIPTION OF THE DRAWINGS

Some example embodiments of the present disclosure will be described hereinafter with reference to the accompanying drawings, in which:

FIG. 1 is a perspective view of an outer appearance of an upright piano;

FIG. 2 is a perspective view of the upright piano viewed from a back side;

FIG. 3 is an enlarged view of an attachment portion of a muffler rail;

FIG. 4 is a perspective view of the muffler rail and a cap member for the muffler rail;

FIG. 5 is a perspective view of the muffler rail with the cap member attached;

FIG. 6 is a perspective view of a cap member for a hammer rail;

FIG. 7 is a perspective view of the hammer rail and the cap member for the hammer rail;

FIG. 8 is a perspective view of the hammer rail with the cap member attached;

FIG. 9 is a perspective view of a cap member for a balance lever rail;

FIG. 10 is a perspective view of the cap member for the balance lever rail; and

FIG. 11 is a perspective view of the balance lever rail with the cap member attached.

### DETAILED DESCRIPTION OF EXEMPLARY EMBODIMENTS

### 1. Embodiment

### 1-1. Overall Configuration

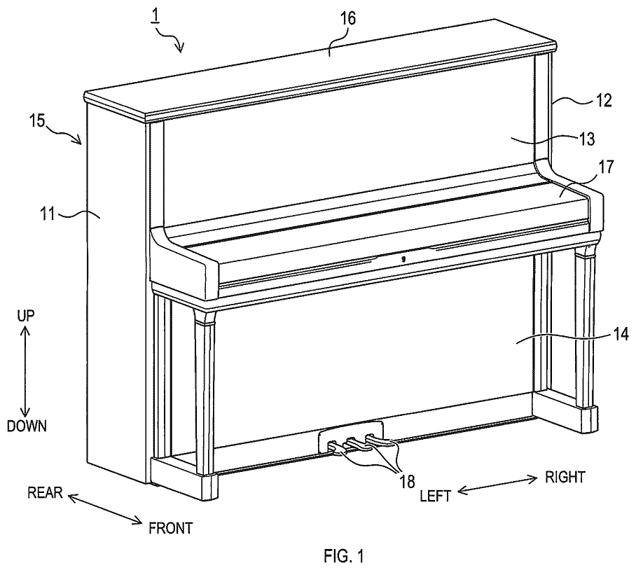

FIG. 1 shows an upright piano 1 (hereinafter, also referred to as simply “piano 1”) of the present embodiment. The piano 1 comprises a left side board 11, a right side board 12, an upper front board 13, a lower front board 14, a back board 15, a top board 16, a keyboard cover 17, and pedals 18.

The piano 1 further comprises a keyboard and an action mechanism. The keyboard and the action mechanism are not directly related to the problems to be solved by the present disclosure; thus, illustration and description of the keyboard and the action mechanism are omitted.

In the following description, when the piano 1 is viewed from its player, the near side (see FIG. 1) will be described as “front”, the far side as “rear”, the upper side as “up”, the lower side as “down”, the left side as “left”, and the right side as “right”.

The left side board 11 is a plate member arranged on the left side of the piano 1. The right side board 12 is a plate member arranged on the right side of the piano 1. The upper front board 13 is a plate member arranged on the upper near side of the piano 1. The lower front board 14 is a plate member arranged on the lower near side of the piano 1. The back board 15 is a plate member arranged on the far side (in other words, the rear side) of the piano 1.

The upper front board 13, the lower front board 14, and the back board 15 are configured in a removable (openable) manner.

The top board 16 is arranged on top of the left side board 11, the right side board 12, the upper front board 13, and the back board 15. Although it is not shown in the drawing, the top board 16 is configured in an openable and closable manner via at least one hinge (not shown).

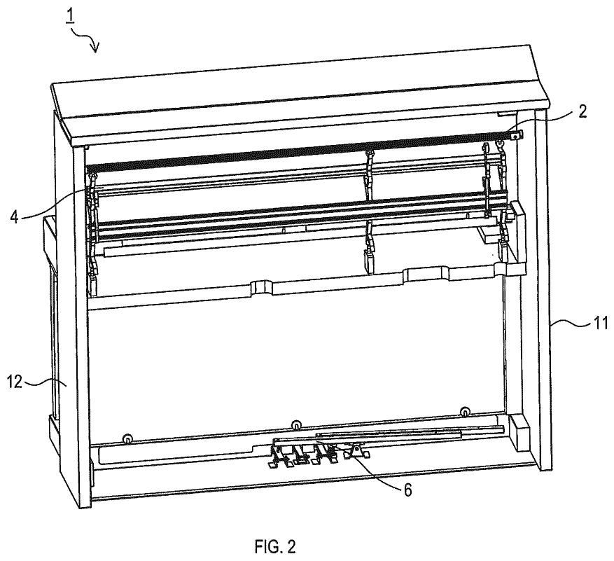

FIG. 2 is a perspective view of the piano 1 viewed from the rear side (back side). Specifically, FIG. 2 shows the piano 1 with the back board 15 removed (or unattached).

The piano 1 comprises rail components including a muffler rail 2, a hammer rail 4, and a balance lever rail 6. The muffler rail 2, the hammer rail 4, and the balance lever rail 6 each have an elongated shape and a hollow structure. Each rail component will be described in detail below.

### 1-2. Muffler Rail

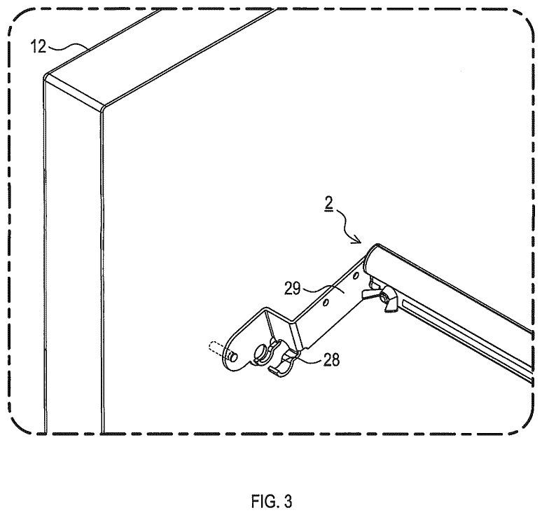

FIGS. 3 to 5 show the muffler rail 2 and a cap member 3 for the muffler rail 2.

The muffler rail 2 is linked to operation (movement) of a muffler lever (or muffler pedal) for muffling or reducing sounds, and is configured to transmit the operation force. Specifically, the muffler rail 2 comprises a felt curtain (not shown) attached to and hanging down from the muffler rail 2 along the entire longitudinal length of the muffler rail 2.

The muffler rail 2 is configured such that, in response to operation of the muffler lever (or muffler pedal), the muffler rail 2 pivots so that the felt curtain is placed between strings and hammers of the piano 1. This muffles or reduces the sound.

FIG. 3 is an enlarged view of an attachment portion at a first end of the muffler rail 2, which is one of those at both ends of the muffler rail 2. The first end of the muffler rail 2 is configured to be attached to the right side board 12 via a metal bracket 29 in the case of FIG. 3. Of the two ends of the muffler rail 2, a second end (not shown) is configured to be attached to the left side board 11 by means of the same or a similar configuration. The bracket 29 is pivotable about a rotational shaft (not shown) supported by a rotational shaft holder 28. This enables the muffler rail 2 to pivot together with the bracket 29.

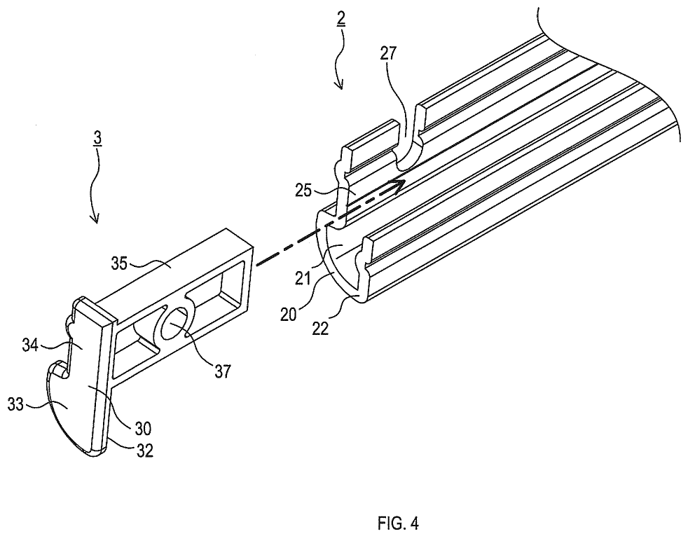

Referring to FIGS. 3 and 4, the muffler rail 2 and the cap member 3 for the muffler rail 2 will be further described.

The muffler rail 2 is made of metal, preferably aluminum. The muffler rail 2 has an elongated shape (configuration). The muffler rail 2 is hollow and comprises a hollow portion 21.

The muffler rail 2 is fabricated to a required length by cutting a base material member with a certain length to a desired length. Due to the cutting, a cut surface 22 is formed at both ends of the muffler rail 2.

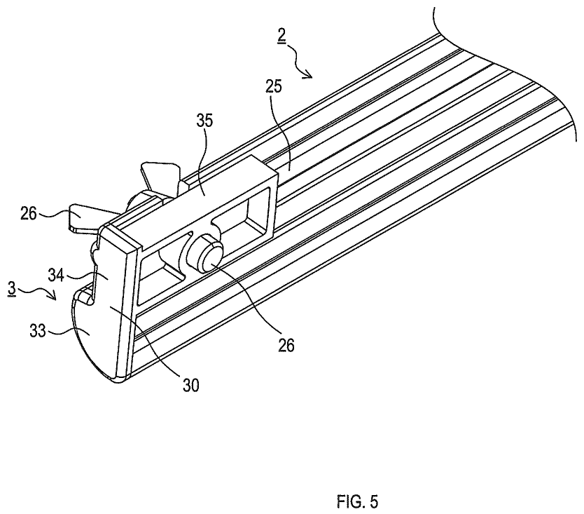

The muffler rail 2 comprises an arc-shaped portion 20 having a substantially arc-shaped cross section, and a lateral plate portion 25 having a shape that can be recognized as a plate shape or a rectangular shape. The lateral plate portion 25 comprises a screw hole 27 configured to receive a thumbscrew 26 (see FIG. 5) with which the muffler rail 2 and the cap member 3 are secured to the bracket 29.

The cap member 3 is attached to each longitudinal end of the muffler rail 2. Although FIG. 4 only shows the first end, the second end is configured in the same manner; thus, illustration and description of the second end are omitted here.

The cap member 3 may be understood as a separate component independent of the muffler rail 2, or the muffler rail 2 and the cap member 3 may be understood as an integrated component (in other words, the muffler rail 2 includes the cap member 3).

Because the cap members 3 are configured to be attached to the muffler rail 2, the muffler rail 2 is cut (machined) to be shorter than common muffler rails (in other words, muffler rails with no members, such as the cap members 3, to be attached) as much as the extra length to be added by the cap members 3.

The cap member 3 comprises a cover portion 30 and a rectangular portion 35. The cover portion 30 is configured to substantially cover the opening and the cut surface 22 of the first end of the muffler rail 2. The cover portion 30 comprises a cover surface 32 at a location corresponding to the location of the cut surface 22 in a state where the cap member is assembled to the muffler rail 2. The cover surface 32 is configured to contact and thereby cover the cut surface 22. The cover portion 30 comprises an arc-shaped plate portion 33 and a rectangular plate portion 34. The arc-shaped plate portion 33 has a shape, corresponding to the arc-shaped portion 20 of the muffler rail 2, substantially identical to the outer shape of the arc-shaped portion 20. The rectangular plate portion 34 has a rectangular shape.

The cover surface 32 of the cover portion 30 may be configured to closely contact the cut surface 22. However, the cover portion 30 does not necessarily have to be configured to contact the cut surface 22 and may be configured to be in close proximity to the cut surface 22. It is aesthetically preferable that a gap is not created, and that the cover surface 32 is configured to be closely contact the cut surface 22 without any gap therebetween.

The rectangular portion 35 is integrally formed with the cover portion 30 and substantially continuous with the rectangular plate portion 34. The rectangular portion 35 is configured to be inserted in a sliding manner in contact with or in close proximity to the inner surface of the lateral plate portion 25, and housed entirely in the muffler rail 2.

The rectangular portion 35 comprises a threaded hole 37 configured to threadably receive the thumbscrew 26. With the cap member 3 assembled to the muffler rail 2, the screw hole 27 and the threaded hole 37 are aligned. The muffler rail 2 together with the cap member 3 is coupled to the bracket 29 via the thumbscrew 26.

FIG. 5 shows a state of the cap member 3 attached to the muffler rail 2. As shown in FIG. 5, in the state where the cap member 3 is attached to the muffler rail 2, the rectangular portion 35 of the cap member 3 is housed in the muffler rail 2, and the cover portion 30 closely covers and hides the cut surface 22 of the muffler rail 2. In contrast, the cover portion 30 is exposed in a visible manner.

The cap member 3 is formed of acrylonitrile butadiene styrene (ABS) resin. The material of the cap member 3 is not limited to ABS resin, and other types of resin may be used. The cap member 3 may be made of metal. In a case where the cap member 3 is made of metal, it is desirable that the material of the cap member 3 is the same as that of the muffler rail 2.

The cap member 3 may be plated. Brass may be used as a coating material for the plating.

The cap member 3 may be polished. In this case, the cap member 3 may be polished in its resin-exposed state or in its plated state.

Since the cap member 3 is configured to cover the cut surface 22 of the muffler rail 2, it is possible to avoid injury and other inconveniences due to burrs or other sharp projections, even if any of those have remained on the cut surface 22.

By improving the aesthetics of the cap member 3, more specifically that of the cover portion 30, while avoiding impairment of the aesthetics due to the cut surface 22, it is possible to improve the aesthetics of the entire muffler rail 2, and consequently, that of the piano 1.

### 1-3. Hammer Rail

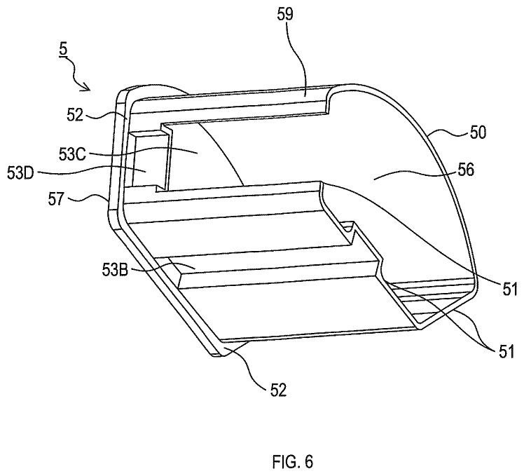

FIGS. 6 to 8 shows the hammer rail 4 and a cap member 5 for the hammer rail 4.

The hammer rail 4 is attached to a hammer assembly (not shown), which is configured to strike the strings, and supports the hammers.

The hammer rail 4 is made of metal, preferably aluminum. The hammer rail 4 has an elongated shape (configuration). The hammer rail 4 is hollow and comprises a hollow portion 49.

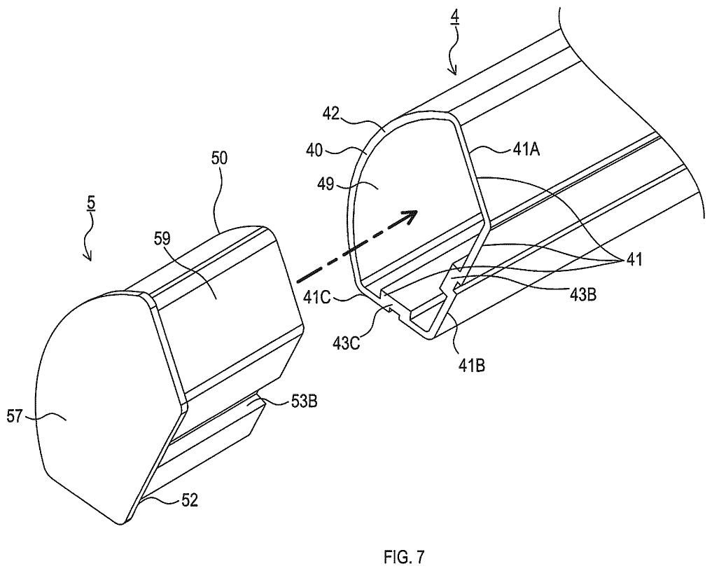

The hammer rail 4 is fabricated to a required length by cutting a base material member with a certain length to a desired length. Due to the cutting, a cut surface 42 (see FIG. 7) is formed at both ends of the hammer rail 4.

FIG. 7 shows a first end of the two longitudinal ends of the hammer rail 4. The other end of the hammer rail 4 is not shown in the drawing, but has the same configuration.

The hammer rail 4 comprises an arc-shaped portion 40 having an arc-shaped (a substantially sector-shaped) cross section, and a trapezoidal portion 41 having a substantially trapezoidal cross section overall. The hammer rail 4 has a structure enclosed by walls formed by the arc-shaped portion 40 and the trapezoidal portion 41 and hollow inside overall.

The trapezoidal portion 41 comprises substantially flat plate portions 41A, 41B, and 41C that are substantially flat (and substantially straight as sides of a cross section).

The substantially flat plate portion 41A is flat overall. The substantially flat plate portion 41B comprises a rail portion 43B protruding inward. The substantially flat plate portion 41C comprises a rail portion 43C protruding inward.

The cap member 5 comprises a lid portion 57 and a body portion 59. The lid portion 57 is integrally formed with the body portion 59.

The lid portion 57 has a generally flat plate shape (configuration). The lid portion 57 is formed in a flange like manner, protruding from the body portion 59, and comprises a flange surface 52. The outer shape of the lid portion 57 substantially corresponds to that of the cross section of the hammer rail 4.

The body portion 59 is hollow and has a cavity portion 56. The body portion 59 is formed to such a shape that its outer shape substantially corresponds to the shape of the hollow portion 49 of the hammer rail 4 (in other words, the shape formed by the inner peripheral surface of the hammer rail 4).

The body portion 59 comprises an arc-shaped portion 50 and a trapezoidal portion 51. The arc-shaped portion 50 is arc-shaped (substantially sector-shaped) corresponding to the arc-shaped portion 40 of the hammer rail 4. The trapezoidal portion 51 is substantially trapezoidal overall. The body portion 59 comprises a recessed portion 53B configured to receive and mate with the rail portion 43B of the hammer rail 4. The body portion 59 further comprises a cutout portion 53C configured to avoid overlapping with the rail portion 43C. The body portion 59 further comprises a recessed portion 53D located as a continuation of the cutout portion 53C and configured to receive and mate with a portion of the rail portion 43C.

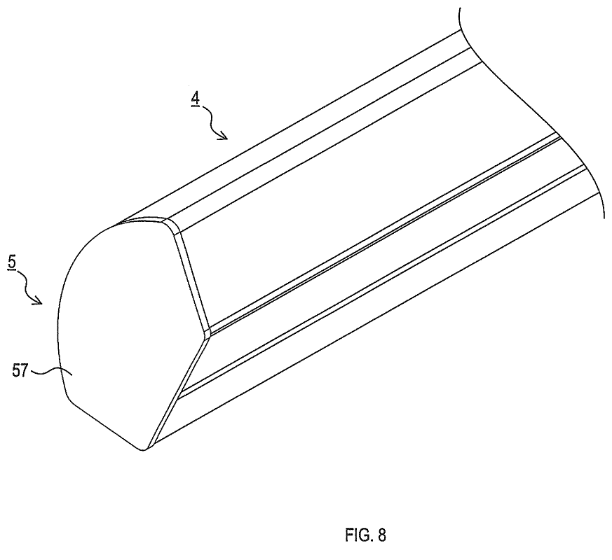

FIG. 8 shows the cap member 5 assembled to the hammer rail 4. As described above, the assembled (secured) state is achieved by the body portion 59 of the cap member 5 mating with the hollow portion 49 of the hammer rail 4 and being housed in the hammer rail 4. More specifically, the secured state is achieved by contact friction generated by the outer peripheral surface of the body portion 59 contacting the inner circumferential surface of the hammer rail 4.

In this case, the hammer rail 4 and the cap member 5 may be configured such that the contact friction is better maintained by mating between the rail portion 43B and the recessed portion 53B. Similarly, the hammer rail 4 and the cap member 5 may be configured such that the contact friction is better maintained by the mating between the rail portion 43C and the recessed portion 53D.

The outer shape of the lid portion 57 substantially corresponds to that of the cross section of the hammer rail 4. Thus, the cap member 5 (the lid portion 57) and the hammer rail 4 in their assembled state extend in a continuous and integrated manner and can provide a unified appearance.

The cap member 5 is formed of ABS resin. The material of the cap member 5 is not limited to ABS resin, and other types of resin may be used. The cap member 5 may be made of metal. In a case where the cap member 5 is made of metal, it is desirable that the material of the cap member 5 is the same as that of the hammer rail 4.

The cap member 5 may be plated. Brass may be used as a coating material for the plating.

The cap member 5 may be polished. In this case, the cap member 5 may be polished in its resin-exposed state or in its plated state.

Since the cap member 5 is configured to cover the cut surface 42 of the hammer rail 4, it is possible to avoid injury and other inconveniences due to burrs or other sharp projections, even if any of those have remained on the cut surface 42.

By improving the aesthetics of the cap member 5, more specifically that of the lid portion 57, while avoiding impairment of the aesthetics due to the cut surface 42, it is possible to improve the aesthetics of the entire hammer rail 4, and consequently, that of the piano 1.

### 1-4. Balance Lever Rail

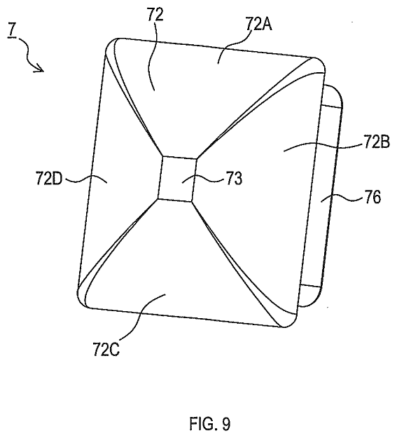

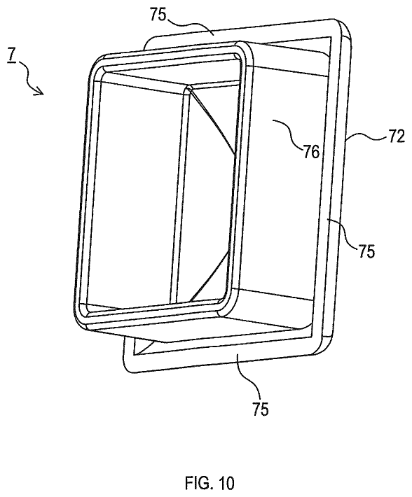

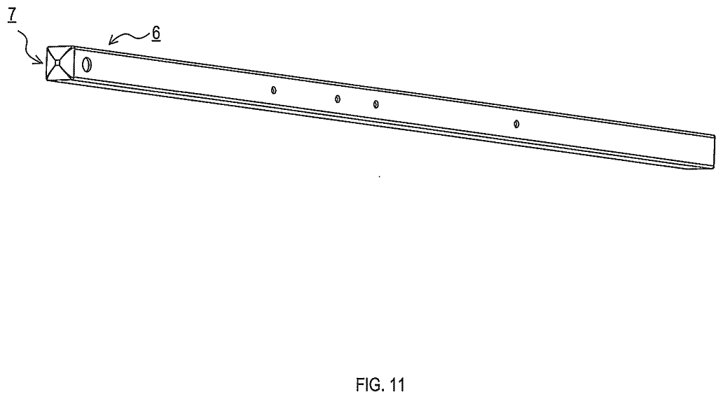

FIG. 9 to 11 show the balance lever rail 6 and a cap member 7 for the balance lever rail 6.

The balance lever rail 6 is coupled to a foot pedal and linked to operation (movement) of the pedal to transmit the operation force.

The balance lever rail 6 is made of metal, preferably aluminum. The balance lever rail 6 has an elongated shape (configuration). The balance lever rail 6 is hollow. More specifically, the balance lever rail 6 is substantially rectangular-cuboid-shaped. The cross-sectional shape of the balance lever rail 6 is substantially square.

The balance lever rail 6 is fabricated to a required length by cutting a base material member with a certain length to a desired length. Due to the cutting, a cut surface is formed at both ends of the balance lever rail 6.

The cap member 7 comprises a lid portion 72 and a body portion 76.

The lid portion 72 has a substantially quadrangular shape and is shaped like an umbrella with a central top portion 73 at the top. The lid portion 72 comprises four surface sections 72A, 72B, 72C, and 72D. The lid portion 72 further comprises a flange surface 75. The flange surface 75 contacts and covers a cut surface (not shown) of the balance lever rail 6.

The body portion 76 is integrally formed with the lid portion 72 and has a substantially rectangular cuboid shape. The outer shape of the body portion 76 substantially corresponds to the shape of the inner periphery of the balance lever rail 6. In other words, the body portion 76 is configured to mate with and be housed in the balance lever rail 6. The body portion 76 is configured to contact the cavity surface (inner surface) of the balance lever rail 6, and securing of the cap member 7 to the balance lever rail 6 is maintained by contact friction generated by the contact.

In a state where the cap member 7 is assembled to the balance lever rail 6, the body portion 76 is housed in the balance lever rail 6 and the lid portion 72 is exposed.

The cap member 7 is formed of ABS resin. The material of the cap member 7 is not limited to ABS resin, and other types of resin may be used. The cap member 7 may be made of metal. In a case where the cap member 7 is made of metal, it is desirable that the material of the cap member 7 is the same as that of the balance lever rail 6.

The cap member 7 may be plated. Brass may be used as a coating material for the plating.

The cap member 7 may be polished. In this case, the cap member 7 may be polished in its resin-exposed state, or in its plated state.

Since the cap member 7 is configured to cover the cut surface of the balance lever rail 6, it is possible to avoid injury and other inconveniences due to burrs or other sharp projections, even if any of those have remained on the cut surface.

By improving the aesthetics of the cap member 7, more specifically that of the lid portion 72, while avoiding impairment of the aesthetics due to the cut surface, it is possible to improve the aesthetics of the entire balance lever rail 6, and consequently, that of the piano 1.

### 1-5. Other Effects

The cap members 3, 5, and 7 are configured with ABS resin that has excellent productivity, durability, heat resistance, dimensional stability, chemical resistance, and other advantageous attributes. ABS resin possesses a feature that yields advantages of resin while facilitating easy plating. Thus, ABS resin is advantageous in terms of workability.

Use of ABS resin enables weight reduction. This enables reduction of transportation costs, load on workers, and other resource requirements, for example.

Plating on ABS resin enables not only improvement of the aesthetics but also improvement of the durability of the cap members 3, 5, and 7. Use of ABS resin is advantageous in terms of ease of manufacturing and simplicity of equipment and enables reduction of manufacturing costs, compared with a case of metal cap members.

In a case where brass is used as a coating material for plating, it is possible to provide antique-style aesthetics.

### 1-6. Situations Where Effects Are Exhibited

In the piano 1, the upper front board 13 and the lower front board 14 are removable. The upper front board 13 and the lower front board 14 may be removed for maintenance, optimization of acoustic effects, and for other reasons.

The top board 16 is pivotable, and it is thus possible to lift and pivot (open) the top board 16. The top board 16 also may be lifted and opened for optimization of acoustic effects.

In such cases, the internal structure of the piano 1, including the rail components, may be visible to a user and third parties. For this reason, the internal structure may affect the aesthetics.

Even in such situations, it is possible to avoid impairing the aesthetics by using the cap members 3, 5, and 7. Furthermore, providing improved aesthetics of the cap members 3, 5, and 7 makes it possible to improve the aesthetics of the interior of the piano 1, and consequently, that of the entirety of the piano 1, even in the aforementioned situations.

### 2. Other Embodiments

The cap members 3, 5, and 7 may be produced by injection molding. In this case, the mold(s) used for the injection molding may be polished to eliminate the need for further polishing of finished components after the molding.

The cap members 3, 5, and 7 may be provided at at least one end of respective rail components. It is desirable that the cap members 3, 5, and 7 are provided at both ends (two ends) of the respective rail components.

The cap members 3, 5, and 7 are made of ABS resin. However, the materials of the cap members 3, 5, and 7 are not limited to ABS resin. For example, it is possible to use metal. Apart from this, the cap members 3, 5, and 7 may be made of wood, stone, or other types of resin.

Brass has been mentioned as a coating material for plating. However, the coating material is not limited to brass. Other types of coating material may be used according to the materials of the rail components.

Functions of a single element in the aforementioned embodiments may be achieved by two or more elements, or a function of a single element may be achieved by two or more elements. Functions of two or more elements may be achieved by a single element, or a function achieved by two or more elements may be achieved by a single element. A part of the configurations in the aforementioned embodiments may be omitted. At least a part of the configurations in the aforementioned embodiments may be added to or replaced with another configuration in the aforementioned embodiments.

What is claimed is:

1. A rail component for use in a keyboard instrument, the rail component comprising:
an elongated and hollow structure; and
at least one cap member covering at least one of two longitudinal ends of the rail component.

2. The rail component according to claim 1, wherein the cap member comprises a material consisting of acrylonitrile butadiene styrene (ABS) resin.

3. The rail component according to claim 1, wherein the cap member comprises a plated surface.

4. The rail component according to claim 3, wherein the plated surface is configured with a coating material comprising brass.

5. The rail component according to claim 1, wherein the cap member comprises a polished surface.

6. The rail component according to claim 2, wherein the cap member comprises a polished surface.

7. The rail component according to claim 3, wherein the cap member comprises a polished surface.

8. The rail component according to claim 4, wherein the cap member comprises a polished surface.

9. A cap member for a rail component, the rail component being configured for use in a keyboard instrument and having an elongated and hollow structure,
the cap member being configured to cover at least one of two longitudinal ends of the rail component.
